(19) United States
(12) Patent Application Publication
(10) Pub. No.: US 2024/0016274 A1
(43) Pub. Date: Jan. 18, 2024

(54) BAG FOR MOUTHPIECES

(71) Applicant: ERIC SUNG-UN CHOE, QINGDAO (CN)

(72) Inventor: ERIC SUNG-UN CHOE, QINGDAO (CN)

(21) Appl. No.: 17/970,745

(22) Filed: Oct. 21, 2022

(30) Foreign Application Priority Data
Jul. 15, 2022 (CN) 202221829730.9

(51) Int. Cl. A45C 11/24; A45C 13/02; A45C 13/10; G10G 7/00

(52) U.S. Cl. CPC A45C 11/24; A45C 13/02; A45C 13/103; G10G 7/005

(57) ABSTRACT

A mouthpiece includes a main body including a mouthpiece storage bag and an accessory storage bag. The mouthpiece storage bag is integrated with the accessory storage bag. A plurality of clip stands and a plurality of connecting bracket are arranged in the mouthpiece storage bag. Each of the clip stands is bonded in the mouthpiece storage bag through a first VELCRO arranged on a bottom portion of each of the clip stands and each of the connecting brackets is bonded in the mouthpiece storage bag through a second VELCRO arranged on a bottom portion of each of the connecting brackets. The plurality of connecting brackets is sequentially arranged adjacent to one side of the plurality of clip stands. A groove receiving a mouthpiece is formed between each two adjacent connecting brackets. The mouthpiece storage bag stores mouthpieces and clips and the accessory storage bag stores accessories.

### TECHNICAL FIELD

The present disclosure relates to a technical field of musical instrument storage, and in particular to a bag for mouthpieces.

### BACKGROUND

A mouthpiece is one of the most important components of a musical instrument, and quality of the mouthpiece is particularly important. Timbre of music is not only affected by a performer's mouth shape and breath, but also affected by a material, a specification, and a shape of the mouthpiece. The mouthpiece directly affects sound quality, pitch, and volume of the music. Therefore, daily maintenance of the mouthpiece is very important. When the performer goes out to perform, conventional mouthpieces are inconvenient to carry. Moreover, improper carrying and storage would cause damage to the conventional mouthpieces.

Currently, there are various bags for mouthpieces configured to protect the mouthpieces on a market. However, the bags for mouthpieces can only storage the mouthpieces, and other accessories related to the mouthpieces cannot be stored. If the mouthpieces and the accessories are put together, storage of the mouthpieces and the accessories is chaotic and it is inconvenient to take out a required mouthpiece or a required accessory.

### SUMMARY

In view of above-mentioned technical deficiencies, a purpose of the present disclosure is to provide a bag for mouthpieces to solve problems raised in the prior art.

In order to solve the above-mentioned technical problems, the present disclosure adopts following technical solutions. The present disclosure provides a bag for mouthpieces. The mouthpiece comprises a main body. The main body comprises a mouthpiece storage bag and an accessory storage bag. The mouthpiece storage bag is integrated with the accessory storage bag. A plurality of clip stands and a plurality of connecting bracket are arranged in the mouthpiece storage bag. A first VELCRO is arranged on a bottom portion of each of the clip stands and a second VELCRO is arranged on a bottom portion of each of the connecting brackets. Each of the clip stands is bonded in the mouthpiece storage bag through each first VELCRO and each of the connecting brackets is bonded in the mouthpiece storage bag through each second VELCRO. The plurality of connecting brackets is sequentially arranged adjacent to one side of the plurality of clip stands. A groove is formed between each two adjacent connecting brackets. Each groove is configured to receive a mouthpiece.

Optionally, zippers are sewn on the mouthpiece storage bag and the accessory storage bag.

Optionally, each of the clip stands comprises a clip stand base and a clip stand upper body. Each clip stand base is disc-shaped. Each clip stand upper body is cylindrical. Each clip stand base is integrated with a corresponding clip stand upper body.

Optionally, each of the connecting bracket comprises a connecting bracket base and a connecting bracket upper body. Each connecting bracket base is elliptical. Each connecting bracket upper body is cloud-shaped. Each connecting bracket base is integrated with a corresponding connecting bracket upper body.

Optionally, sizes of the plurality of clip stands are different and sizes of the plurality of connecting brackets are different.

Optionally, a carrying strap is connected to one side of the main body.

The accessory storage bag stores accessories such as reed boxes, cleaning cloths, mouthpiece brushes, reeds, etc. Each mouthpiece is placed in a corresponding groove formed between two adjacent connecting brackets. Each of the clip brackets is configured to sleeve a clip. The user is able to store or take out the mouthpieces, the clips, and required accessories in an orderly manner, avoiding a situation of wear and tear caused by a collision between the mouthpieces, the clips, and the accessories.

The carrying strap is connected to the one side of the main body. When going out with the bag for mouthpieces, the user is able to hold the carrying strap which does not strangle the user's hand and makes the mouthpiece convenient to carry.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor. In the drawing:

FIG. 1 is a schematic diagram of a mouthpiece according to one embodiment of the present disclosure.

FIG. 2 is a schematic diagram of a clip stand according to one embodiment of the present disclosure.

FIG. 3 is a schematic diagram of a connecting bracket according to one embodiment of the present disclosure.

In the drawings:

1—main body, 2—mouthpiece storage bag, 3—accessoriy storage bag, 4—clip stand, 5—connecting bracket, 6—carrying strap, 7—zipper; 401—clip stand base, 402—clip stand upper body, 501—connecting bracket base, and 502—connecting bracket upper body; 503—second VELCRO.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

It should be understood that in the description of the present disclosure terms such as “upper”, “lower”, “front”, “rear”, “left”, “right”, “top”, “bottom”, “inner”, “outer”, etc. indicate direction or position relationships shown based on the drawings, and are only intended to facilitate the description of the present disclosure and the simplification of the description rather than to indicate or imply that the indicated device or element must have a specific direction or constructed and operated in a specific direction, and therefore, shall not be understood as a limitation to the present disclosure.

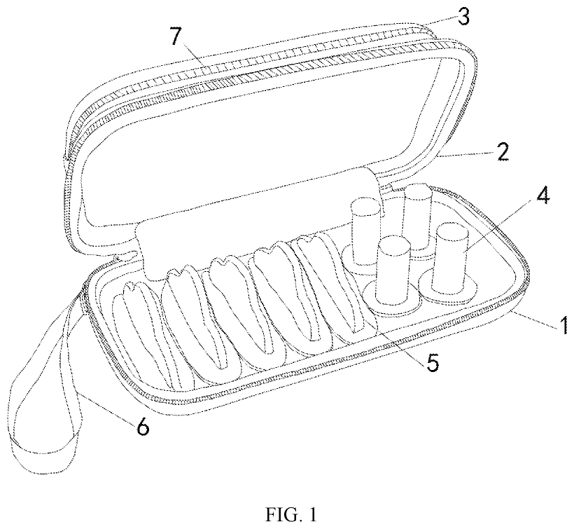

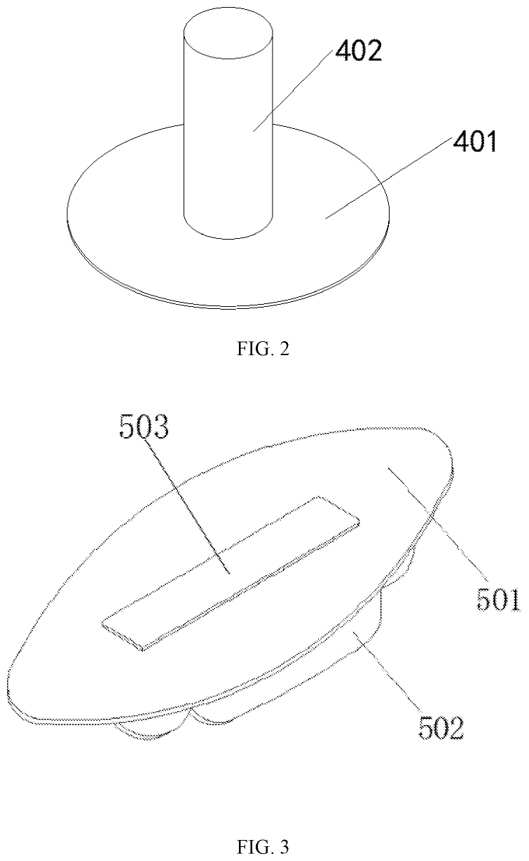

As shown in FIGS. 1-5, the present disclosure provides a bag for mouthpieces. The mouthpiece comprises a main body 1. The main body 1 comprises a mouthpiece storage bag 2 and an accessory storage bag 3. The mouthpiece storage bag 2 is integrated with the accessory storage bag 3. A plurality of clip stands 4 and a plurality of connecting bracket 5 are arranged in the mouthpiece storage bag 2. A first VELCRO is arranged on a bottom portion of each of the clip stands 4 and a second VELCRO is arranged on a bottom portion of each of the connecting brackets 5. Each of the clip stands 4 is bonded in the mouthpiece storage bag 2 through each first VELCRO and each of the connecting brackets 5 is bonded in the mouthpiece storage bag 2 through each second VELCRO 503. The plurality of connecting brackets 5 is sequentially arranged adjacent to one side of the plurality of clip stands 4. A groove is formed between each two adjacent connecting brackets 5. Each groove is configured to receive a mouthpiece.

A bottom portion of the mouthpiece storage bag 2 is reinforced by sewing threads to prevent a lining of the mouthpiece storage bag 2 from being taken up when the plurality of clip stands 4 and the plurality of connecting brackets 5 move.

The first VELCRO is arranged on the bottom portion of each of the clip stands 4 and the second VELCRO is arranged on the bottom portion of each of the connecting brackets 5. Therefore, the plurality of clip stands 4 and the plurality of connecting brackets 5 are capable of being bonded to any position in the mouthpiece storage bag 2, and a user is able to freely organize and move the plurality of clip stands 4 and the plurality of connecting brackets 5 according to his needs.

The accessory storage bag is configured to store accessories such as reed boxes, cleaning cloths, mouthpiece brushes, reeds, etc.

Sizes of the plurality of clip stands are different and sizes of the plurality of connecting brackets are different. Therefore, the plurality of clip stands and the plurality of connecting brackets are adapted to the clips with different specifications and the mouthpieces with different specifications.

Furthermore, zippers 7 are sewn on the mouthpiece storage bag 2 and the accessory storage bag 3. The zippers 7 are configured to zip or unzip the mouthpiece storage bag 2 and the accessory storage bag 3.

Furthermore, each of the clip stands 4 comprises a clip stand base 401 and a clip stand upper body 402. Each clip stand base 401 is disc-shaped. Each clip stand upper body 402 is cylindrical. Each clip stand base 401 is integrated with a corresponding clip stand upper body 402.

Since each of the clips is sleeved on a corresponding clip stand 4, the user can take and place required clips in an orderly manner. The clips do not contact each other, thereby avoiding wear of the clips.

Furthermore, each of the connecting bracket 5 comprises a connecting bracket base 501 and a connecting bracket upper body 502. Each connecting bracket base 501 is elliptical. Each connecting bracket upper body 502 is cloud-shaped. Each connecting bracket base 501 is integrated with a corresponding connecting bracket upper body 502.

Each mouthpiece is placed in a corresponding groove formed by two adjacent connecting bracket 5. Each connecting bracket upper body 502 is configured to separate two adjacent mouthpieces, so that the mouthpieces are taken and placed in a convenient and orderly manner, which avoids collision and wear of the mouthpieces.

Furthermore, a carrying strap 6 is connected to one side of the main body 1. When carrying, the bag for the mouthpieces may be hung on a wrist or on a shoulder of the user through the carrying strap 6, which is used in various ways.

A wording principle of the bag for the mouthpieces is as follow.

The zipper 7 of the mouthpiece storage bag 2 is unzipped. Then the mouthpieces are put into the grooves formed by the plurality of connecting brackets after the plurality of connecting bracket 5 is connected to the mouthpiece storage bag 2. Each of the clips is sleeved on the corresponding clip stand 4. Therefore, the mouthpieces and the clips are prevented from collision and wear. When the zipper 7 of the accessory storage bag 3 is unzipped, the related accessories of the mouthpieces are put into the accessory storage bag 3. When going out, the user is able to carry the bag for the mouthpieces through the carrying strap 6.

Obviously, those skilled in the art can make various changes and modifications to the embodiments of the present disclosure without departing from the spirit and scope of the embodiments of the present disclosure. Thus, provided that these changes and modifications of the embodiments of the present disclosure fall within the scope of the claims of the present disclosure and their equivalents, then the present disclosure also includes such changes and modifications.

What is claimed is:

1. A bag for mouthpieces, comprising: a main body; wherein the main body comprises a mouthpiece storage bag and an accessory storage bag; the mouthpiece storage bag is integrated with the accessory storage bag; a plurality of clip stands and a plurality of connecting bracket are arranged in the mouthpiece storage bag; a first VELCRO is arranged on a bottom portion of each of the clip stands and a second VELCRO is arranged on a bottom portion of each of the connecting brackets; each of the clip stands is bonded in the mouthpiece storage bag through each first VELCRO and each of the connecting brackets is bonded in the mouthpiece storage bag through each second VELCRO; the plurality of connecting brackets is sequentially arranged adjacent to one side of the plurality of clip stands; a groove is formed between each two adjacent connecting brackets.

2. The bag for the mouthpieces according to claim 1, wherein zippers are sewn on the mouthpiece storage bag and the accessory storage bag.

3. The bag for the mouthpieces according to claim 1, wherein each of the clip stands comprises a clip stand base and a clip stand upper body; each clip stand base is disc-shaped; each clip stand upper body is cylindrical; each clip stand base is integrated with a corresponding clip stand upper body.

4. The bag for the mouthpieces according to claim 1, wherein each of the connecting bracket comprises a connecting bracket base and a connecting bracket upper body; each connecting bracket base is elliptical; each connecting bracket upper body is cloud-shaped; each connecting bracket base is integrated with a corresponding connecting bracket upper body.

5. The bag for the mouthpieces according to claim 1, wherein sizes of the plurality of clip stands are different and sizes of the plurality of connecting brackets are different.

6. The bag for the mouthpieces according to claim 1, wherein a carrying strap is connected to one side of the main body.
